(19) United States
(12) Patent Application Publication
(10) Pub. No.: US 2017/0242115 A1
(43) Pub. Date: Aug. 24, 2017

(54) MULTI-CHANNEL RADAR METHOD AND MULTI-CHANNEL RADAR SYSTEM

(71) Applicant: SIEMENS AKTIENGESELLSCHAFT, München (DE)

(72) Inventors: Sönke Christoph Wilhelm Appel, München (DE); Jörg Hüttner, Hof (DE); Andreas Ziroff, München (DE)

(21) Appl. No.: 15/515,337

(22) PCT Filed: Sep. 21, 2015
(86) PCT No.: PCT/EP2015/071550

§ 371 Date: Mar. 29, 2017

(30) Foreign Application Priority Data
Sep. 30, 2014 (DE) 10 2014 219 773.2

(51) Int. Cl. G01S 13/48

(52) U.S. Cl. CPC G01S 13/48; G01S 13/003

(57) ABSTRACT

A multi-channel radar method is provided for carrying out a transmission by at least two channels, in which at least one channel is provided with a frequency detuning by at least one respective switch for switching a signal amplitude and/or signal phase of the channel.

The present patent document is a §371 nationalization of PCT Application Serial Number PCT/EP2015/071550, filed Sep. 21, 2015, designating the United States, which is hereby incorporated by reference, and this patent document also claims the benefit of DE 10 2014 219 773.2, filed Sep. 30, 2014, which is also hereby incorporated by reference.

### TECHNICAL FIELD

The disclosure relates to a multi-channel radar method and to a multi-channel radar system.

### BACKGROUND

Multi-channel radar systems are becoming increasingly important, in particular with regard to digital beamforming, angle estimation, antenna diversity and a processing gain (e.g., further noise reduction as a result of the processing). For instance, digital beamforming makes it possible for an antenna to be directed at a target in a program-controlled manner. Angle estimates make it possible to measure the angle in relation to the multi-channel radar system in addition to measuring the range. Interference effects may also be reduced by antenna diversity.

However, the technical complexity involved in creating multi-channel radar systems increases linearly with the number of channels. This results in high production costs and a high probability of failure of multi-channel radar systems.

It is known in the case of multi-channel radar systems to provide a receiver and a transmitter for each transmission channel. A transmitter may include a signal generation source, which includes complex devices for linearizing transmitted signals, (e.g., direct digital synthesizers (DDSs), phase-locked loops (PLLs), and mixers). Moreover, it may be necessary to provide amplifier stages. Such transmitters are therefore often complex and expensive.

Receivers, on the other hand, may have a low noise amplifier (LNA), a mixer, an analog-to-digital (AD) converter, and signal processing components. In particular, low noise amplifiers and mixers are respectively to be provided for each receiving channel. Consequently, receivers in multi-channel radar systems also end up being complex and expensive.

### SUMMARY AND DESCRIPTION

The object of the disclosure is to provide a multi-channel radar method that may be carried out easily and at low cost. The object of the disclosure is also to provide a multi-channel radar system that may be produced easily and at low cost.

The scope of the present disclosure is defined solely by the appended claims and is not affected to any degree by the statements within this summary. The present embodiments may obviate one or more of the drawbacks or limitations in the related art.

In the case of the multi-channel radar method for transmitting by at least two channels, at least one channel, every channel, or all but one of the channels, is/are provided with a frequency detuning by in each case at least one switch for switching a signal amplitude and/or signal phase of the channel.

The high system complexity that may be caused by the multi-channel nature of the multi-channel radar system is replaced by a method using switches that provide the signal of a channel in each case with a frequency detuning, (e.g., the frequency is offset). In particular, a switch with a switching frequency characteristic of the particular channel is used for each channel. Consequently, each switch brings about a different frequency detuning for each channel. Away from the switch, the signals may be combined and/or separated on a line by couplers or splitters. In particular, in the case of a multi-channel radar receiver, the method may be boosted by a single low noise amplifier, after which the signal may be mixed by a mixer into an intermediate frequency and subsequently may be digitized by an AD converter. Consequently, the multi-channel radar method may be carried out with simplified hardware. Also, in the case of a multi-channel radar transmitter, only a single direct digital synthesizer (DDS) and one phase-locked loop (PLL) are required for all the channels.

If, on the other hand, a multi-channel radar transceiver is used, it is sufficient to process the unified signal in only one circulator or only one transmitting mixer.

The frequency detunings undertaken by the method may be eliminated by subsequent signal processing. In particular, in the case where the AD converter is operated with a clock derived from a switching frequency, the frequency detuning may be eliminated.

In a development of the multi-channel radar method, the at least two channels are fed in a common transmission path. Consequently, required signal amplifying and processing stages are not necessarily provided redundantly, but may instead be used jointly for all the channels.

In an advantageous development of the multi-channel radar method, the at least two channels are transmitted at the same time. In this development, all of the channels may advantageously be transmitted at the same time, which may not be possible in the case of channels transmitted by the multiplex method.

In the case of the multi-channel radar method, at least one channel, every channel, or all but one of the channels is/are provided with the frequency detuning when transmitting. Alternatively, or in addition, in the case of the multi-channel radar method, at least one channel, every channel, or all but one of the channels is/are provided with the frequency detuning when receiving.

At least one channel, every channel, or all but one of the channels may be provided with such frequency detuning when receiving that corresponds to the frequency detuning with which the channel(s) were provided when transmitting, and, for example, that is the same in amount and not in sign. In this way, the individual channels may be distinguished when transmitting by the frequency detuning, are then transmitted at the same time with this frequency detuning and brought together when receiving in such a way that individual frequency detunings may be reversed.

In an embodiment of the multi-channel radar method, an impedance is switched by the switch. The signal strength of the channel may be switched by the impedance. For example, the signal is switched back and forth between an undiminished signal strength and a lowered signal strength by the switch. In this way, the signal is modulated, but, even if the signal strength is lowered by the switch, the signal is nevertheless transmitted, so that, even when using the multi-channel radar method, sufficiently high transmission values may be achieved.

In one example of the multi-channel radar method, the signal strength of the channel disappears in one switching position of the switch.

In an advantageous embodiment, a signal phase is shifted by one switch of a plurality of switches or by all of the switches. Also, the signal is sufficiently modulated by a shifting of the signal phase. Nevertheless, a high transmission is maintained.

The multi-channel radar system includes at least one multi-channel radar transmission module with at least two channels, in which at least one channel, every channel, or all but one of the channels is/are each provided with a switch by which a signal amplitude or signal phase of the signal may be switched, so that the channel may be provided with a frequency detuning. Consequently, the multi-channel radar method may be advantageously carried out by the multi-channel radar system. In the case of the multi-channel radar system, the multi-channel transmission module is expediently at least one multi-channel radar transmitter or it has such a multi-channel radar transmitter. Alternatively, or in addition, in the case of the multi-channel radar system, the multi-channel transmission module is at least one multi-channel radar receiver or it has such a multi-channel radar receiver.

In an advantageous development, in the case of the multi-channel radar system, the at least one multi-channel transmission module has at least one multi-channel radar transceiver or has such a multi-channel radar transceiver.

### BRIEF DESCRIPTION OF THE DRAWINGS

The disclosure is explained in more detail below based on exemplary embodiments that are represented in the drawings, in which:

FIG. 1 depicts an example of a multi-channel radar system with a multi-channel radar transmitter and a multi-channel radar receiver schematically in a basic diagram.

FIG. 2 depicts an example of a multi-channel radar system with a multi-channel radar transmitter and a radar receiver schematically in a basic diagram.

FIG. 3 depicts an example of a multi-channel radar system with a radar receiver and a multi-channel radar transmitter schematically in a basic diagram.

FIG. 4 depicts an example of a multi-channel radar system with a multi-channel transceiver schematically in a basic diagram,

FIG. 5 depicts an example of a multi-channel radar system in a bistatic arrangement schematically in a basic diagram,

FIG. 6 depicts an example of an offsetting circuit of a multi-channel radar system according to FIGS. 1 to 5 schematically in a basic diagram,

FIG. 7 depicts a further exemplary embodiment of an offsetting circuit as an alternative to the offsetting circuit according to FIG. 6 schematically in a basic diagram.

FIG. 8 depicts a further exemplary embodiment of an offsetting circuit as an alternative to the offsetting circuit according to FIGS. 6 and 7 schematically in a basic diagram.

### DETAILED DESCRIPTION

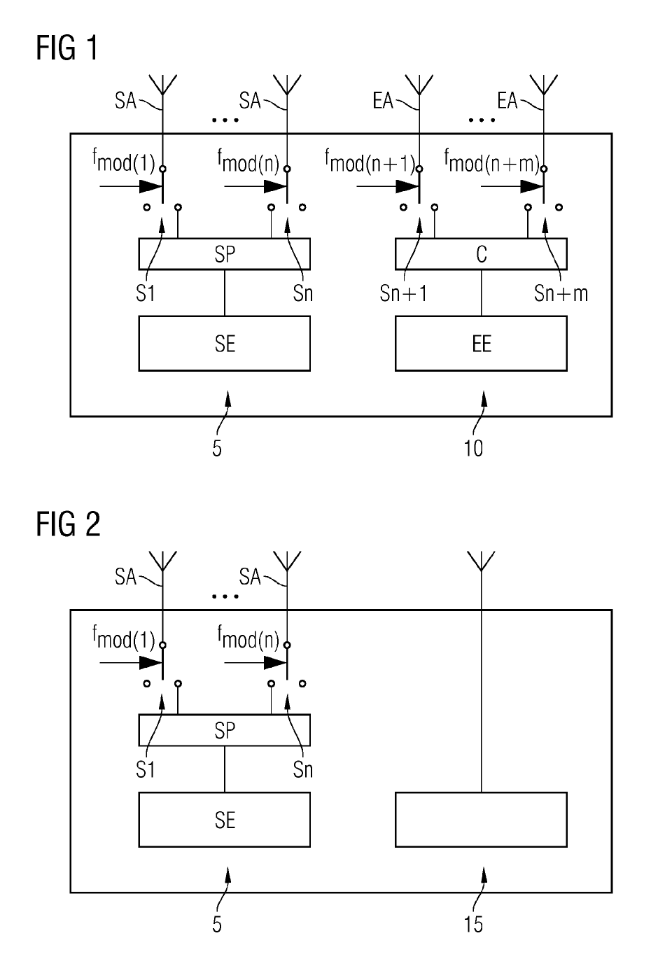

The multi-channel radar system depicted in FIG. 1 includes a multi-channel radar transmitter 5 and a multi-channel radar receiver 10. The multi-channel radar transmitter 5 includes a transmitting unit SE, which feeds a number of transmitting antennas SA by way of a splitter SP.

Each transmitting antenna of the altogether n transmitting antennas SA is connected to the transmitting unit SE by way of a switch S1, . . . Sn, each with its own switching frequency f_{mod(l)} to f_{mod(n)}. In other words, each antenna of the transmitting antennas SA emits its signal with its own frequency detuning.

The multi-channel radar receiver 10 of the multi-channel radar system depicted in FIG. 1 is constructed analogously and includes m receiving antennas EA, which receive a received signal. Each antenna of the receiving antennas EA is connected in each case by way of a switch Sn+1, . . . , Sn+m with its own switching frequency f_{mod(n+1)} to f_{mod(n+m)} to a common combiner C, which passes on the received signal to a receiving unit EE.

It is also possible in principle, as depicted in FIG. 2, in a multi-channel radar system for just one multi-channel radar transmitter 5 to be provided, while the radar transmitter 15 has no offsetting circuit.

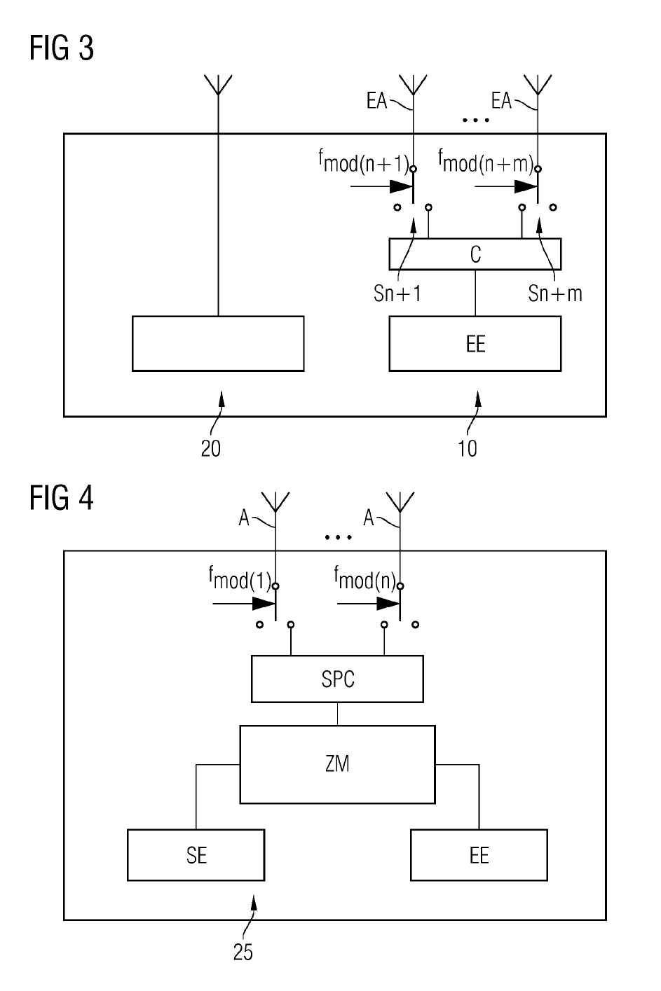

Conversely, as represented in FIG. 3, it is also possible in a multi-channel radar system for just one multi-channel radar receiver 10 to be provided, while the radar transmitter 20 has no offsetting circuit.

In the exemplary embodiment represented in FIG. 4, in the case of a multi-channel radar system, there is a multi-channel radar transceiver 25 instead of a separate multi-channel radar transmitter and a separate multi-channel radar receiver. In this example, the transmitting unit SE and the receiving unit EE are together connected by a circulator or a transmitting mixer ZM by way of n switches with in each case their own switching frequency f_{mod(l)} to f_{mod(n)} to n transmitting and receiving antennas A. Splitters and combiners are formed together as a component SPC that may be handled as one part.

As represented in FIG. 5, a multi-channel radar system may also be formed in a bistatic manner.

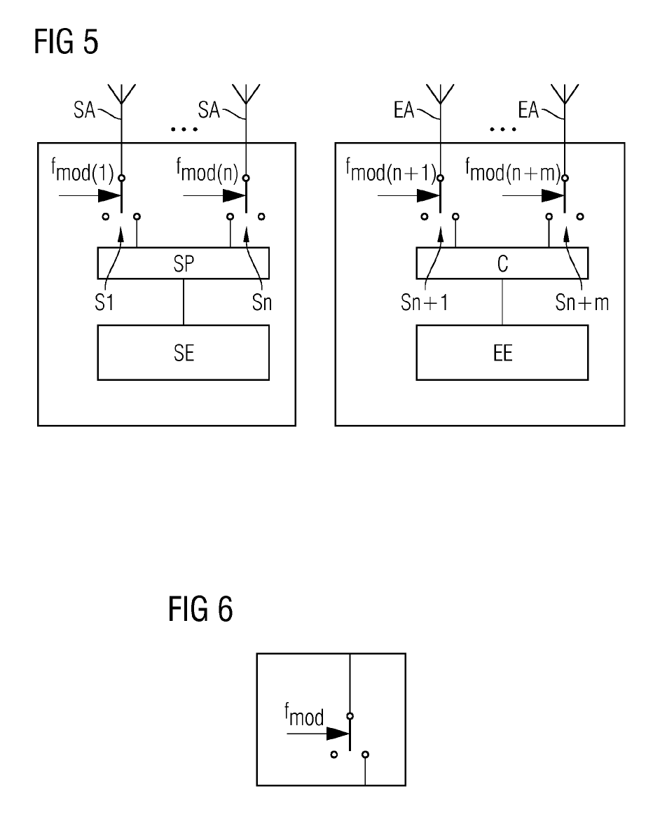

The offsetting circuits used in the previous exemplary embodiments may include simple switches S1, as represented in FIG. 6, which allow the signal strength to be switched to zero with a frequency f_{mod}.

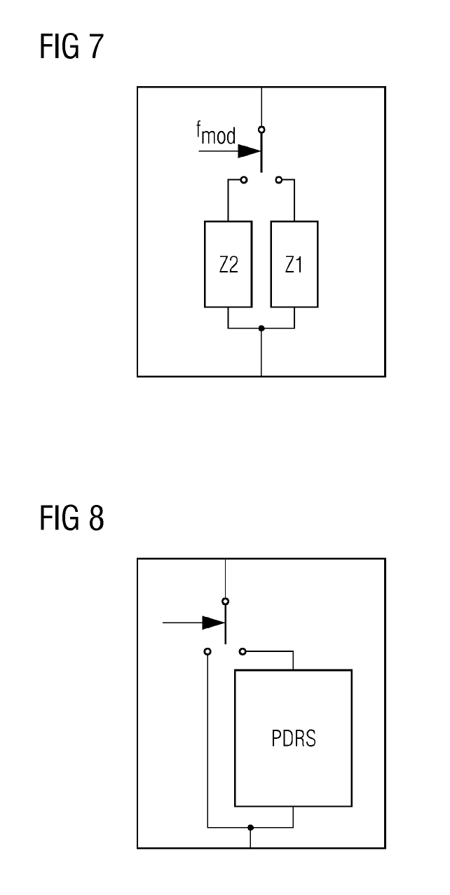

It is alternatively also possible to use switches with switchable impedances as represented in FIG. 7, which switch between an impedance Z1 and Z2 with a frequency f_{mod}.

Furthermore, it is also possible to use a phase rotating switch PDRS as depicted in FIG. 8, which rotates the signal phase.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1-13. (canceled)

14. A multi-channel radar method comprising:
transmitting signals by at least two channels of a multi-channel radar system; and
providing, by at least one switch, a frequency detuning for at least one channel of the at least two channels,
wherein the frequency detuning comprises switching a signal amplitude, a signal phase, or both the signal amplitude and the signal phase of the at least one channel.

15. The multi-channel radar method of claim 14, wherein the frequency detuning is provided for each channel.

16. The multi-channel radar method of claim 14, wherein the at least two channels is greater than two channels, and wherein frequency detuning is provided for all but one of the channels.

17. The multi-channel radar method of claim 14, wherein two channels of the at least two channels are fed in a common transmission path.

18. The multi-channel radar method of claim 14, wherein all channels are fed in a common transmission path.

19. The multi-channel radar method of claim 14, wherein two channels of the at least two channels are transmitted at a same time.

20. The multi-channel radar method of claim 14, wherein all channels are transmitted at a same time.

21. The multi-channel radar method of claim 14, wherein at least one channel of the at least two channels is provided with the frequency detuning when transmitting.

22. The multi-channel radar method of claim 14, wherein each channel of the at least two channels is provided with the frequency detuning when transmitting.

23. The multi-channel radar method of claim 14, wherein at least one channel of the at least two channels is provided with the frequency detuning when receiving.

24. The multi-channel radar method of claim 14, wherein each channel of the at least two channels is provided with the frequency detuning when receiving.

25. The multi-channel radar method of claim 14, wherein at least one channel of the at least two channels is provided in each case with such frequency detuning when receiving that corresponds to the frequency detuning with which the at least one channel was provided in the transmitting.

26. The multi-channel radar method of claim 25, wherein the receiving and transmitting frequencies are a same in amount and not in sign.

27. The multi-channel radar method of claim 14, wherein an impedance is switched by the at least one switch.

28. The multi-channel radar method of claim 14, wherein, in one switching position of a respective switch of the at least one switch, a signal strength of a respective channel disappears.

29. The multi-channel radar method of claim 14, wherein a signal phase is shifted by the at least one switch.

30. A multi-channel radar system comprising:
at least one multi-channel radar transmission module having at least two channels,
wherein at least one channel of the at least two channels comprises a switch configured to switch a signal amplitude or signal phase of the respective channel such that the respective channel is provided with a frequency detuning.

31. The multi-channel radar system of claim 30, wherein each channel comprises a switch.

32. The multi-channel radar system of claim 30, wherein the at least one multi-channel radar transmission module is at least one multi-channel radar transmitter or comprises a multi-channel radar transmitter.

33. The multi-channel radar system of claim 30, wherein the at least one multi-channel transmission module comprises at least one multi-channel receiver.

34. The multi-channel radar system of claim 30, wherein the at least one multi-channel transmission module comprises at least one multi-channel transceiver.
